(19) United States
(12) Patent Application Publication
(10) Pub. No.: US 2003/0050920 A1
(43) Pub. Date: Mar. 13, 2003

(54) Contacts management using virtual subdomains

(76) Inventor: Chen Sun, Houston, TX (US)

Correspondence Address: Chen Sun, 5900 Ranchester Dr. # 706, Houston, TX, 77036, US

(21) Appl. No.: 10/074,081

(22) Filed: Feb. 11, 2002

Related U.S. Application Data
(60) Provisional application No. 60/267,943, filed on Feb. 12, 2001.

(51) Int. Cl. G06F 7/00

(52) U.S. Cl. 707/2

(57) ABSTRACT

WebBIZcontacts stores, searches, retrieves, and presents virtual subdomain addresses with differing domain names where these virtual subdomain addresses have a person's name in the subdomain name and the addressed displayed webpages can show the person's contacts information.

There are two types of WebBIZcontacts. One stores VSAs in a database that when searched, use its VSAs to retrieve contacts information on the Internet. The second had already selectively extracted the VSAs' contacts information from the Internet and stores this information data into a searchable database.

There are many embodiments of these types depending on where the virtual subdomain addresses are stored and what type of communications occurs between the search facility and the virtual subdomain servers.

WebBIZcontacts joined with virtual subdomain addresses form a powerful contacts manager. Virtual subdomain addresses enable a brief and preferred address to communicate a person's identity (WebBIZcard); while, WebBIZcontacts enables for the search, retrieval, and storage of WebBIZcards.

### BACKGROUND

Discussion of Prior Art

Contacts management deals with the storage and retrieval of people's contacts information. Historically, business card holders and address books served this purpose. The onset of computers brought forth databases specifically designed for contacts management, such as ACT, which can be acquired from Symantec Corp., Outlook from Microsoft, and Goldmine from Frontrange Solutions. These non-web-based contacts managers typically contain fields including individual's name, some method of contacting the individual, such as his/her address, telephone number, fax number, the organization he/she represents, and title. Other data fields can include associated office personnel (e.g. assistant's name), birthday, communications activities with the individual, plan of action, digital certificates, IDs, billing information, attachments, hobbies, fields suitable for specific industries, and user defined fields. These non-web-based computer contacts managers automates many of the search and retrieval functions over using paper-based business cards and indexes.

The entry, exchange, update, and graphics requirements of contacts information remains cumbersome for these non-web-based computer contacts manager. The contacts information received by the recipient do not automatically update when the sender's contacts information changes (dynamic updating); entry is typically accomplished by typing; card scanners are time-consuming, inaccurate, and costly; graphics are difficult to handle.

Furthermore a non-web-based computer contacts manager's channels of communications and exchange are usually limited to a few—e.g. only data communications. Channels of contacts information communications can include data communications, email, face-to-face oral, telephony, data import/export, handwriting, and print exchanges.

Even vCard (from Internet Mail Consortium) a standard using data communications for relaying information among non-web-based contacts managers lacks wide and extensive usage, extensive graphics, dynamic updating, and verbal exchange capabilities.

As a result, most contacts information exchange continues to be relayed by telephone (verbally), postal mail (paper business card), or face-to-face exchange (paper business card), and these are usually then manually typed into a non-web-based contacts manager.

Web-based contacts managers have graphical contacts information and dynamic updating, with websites such as Netscape's Net Business Card. In these, the representation of an individual contacts is using a complicated file suffix in the respective website's domain name and the individual's name is behind the domain name. For example, suppose John Smith of Ford Motors (Ford.com) wanted to use a Netscape card. He would receive an URL like Netscape.com/˜d35k/256/JohnSmith, a URL that Ford Motors is hardly likely to approve of. Other web-based contacts manager websites require an individual to use the contacts manager's website domain name plus using assigned codes. patent applications Ser. Nos. 09/476,632, 09/642,127, and No. 60/267,943, filed by Azkar Choudhry and Chen Sun, showed how to build sets of web business cards with people's names in front of an associated domain name, using a technology called virtual subdomain addresses. For example, in the URL JohnSmith.Ford.com, “JohnSmith” is the subdomain name and formed by virtual subdomain technology, Ford.com is the domain name.

These patent applications also contained the computer program code to add web business cards to any domain name. More importantly, the applications explained how any domain name could easily use a remote server (for example, one administered by an outside service) to add such virtual subdomains to an existing domain name. Hence, Ford.com and USPTO.gov can easily provide all its employees virtual subdomain address (VSA) business cards, using the technologies described in three above-mentioned patent applications.

Since multiple domains (e.g. Ford.com and USPTO.gov) are able to create VSA business cards for their employees, there arises a need to store these VSAs with differing domain names, to search on their content, and to retrieve and display the more detailed contacts information. Hence, there is a need for WebBIZcontacts, a contacts manager based on virtual subdomain addresses. Such a WebBIZContacts will allow a user to quickly store, search, and retrieve contacts information that use VSAs with various domain names.

Table 1 below additionally explains the need for WebBIZcontacts and its advantages over prior art. Prior web based technologies use a singular domain unassociated with the person's organization's domain name; use the person's name behind the website's domain name; and are not exchangeable. WebBIZcontacts works on any number of domains and makes VSAs so that the person's name is in front of the domain name and enables for easy exchange of these VSAs.

TABLE 1
Comparison to Prior Art
WebBIZcard &WebBIZcontacts compared to other web contacts managers:
WebBIZContacts with WebBIZcard (WebBIZcard is a VSA with a business card
format output—see FIG. 2) is superior to existing web based contacts
managers.

| | Prior arts' web contacts | VSAs and |
|---|---|---|
| | managers | WebBIZcontacts |
| Easy to remember URL | No. Most people won't use this | Yes |
| having the person's name | type of contacts managers as a | |
| first | result of this. | |
| Uses any domain name | Difficult. Vast majority of people | Yes and easy |
| that gives permission to | won't use this type of contacts | |
| use | managers as a result of this. | |
| Instant creation of virtual | No | Yes |
| subdomains | | |
| Can operate without | No | Yes |
| Internet access | | |
| Uses standard DNS | Yes | No |
| addresses schemes | | |
| Uses Virtual Subdomain | No | Yes |
| Address | | |
| Exchangeable, while using | No | Yes |
| different domain names | | |

### Objects and Advantages

Several objects and advantages of the present invention, WebBIZcontacts, are:

1. Establishes a contacts management system that is easy to communicate because it uses a virtual subdomain address (VSA), which contains the person's name first (subdomain) and his affiliated organization (domain) second. This VSA is easy to remember and short and can be communicated verbally, sent via the Internet as a URL link, sent by other data communications methods, and relayed by simply by writing and forwarding it.

2. Allows for quick entry and storage of contacts information by using a VSA.

3. Can exchange web business cards as each VSA acts as the contacts's “business card” in a WebBIZcontacts.

4. Creates a contacts manager that uses multiple domain names to gather contacts' information.

5. Creates a contacts manager that allows user to store, search, and retrieve on multiple domains.

WebBIZcontacts works on any number of domains and places VSAs so that the person's name is in front of the domain name. Further objects and advantages of my inventions will become apparent from a consideration of the drawings and ensuing description.

### SUMMARY

Three previous patent applications submitted on virtual subdomain technologies—No. 60/267,943, Nos. 09/853,167, and 09/476,632 by Azkar Choudhry and Chen Sun—showed that virtual subdomain addresses can be used to represent a person's business card (called WebBIZcard), can be displayed on a web browser, and can form an index of such business cards. WebBIZcontacts, the subject of this patent application, allows for the storage and retrieval of virtual subdomain addresses of differing domain names into a user-accessible data repository.

There are two types of WebBIZcontacts:

1. A database of virtual subdomain addresses and a search facility that can search the web content of the addresses.

2. A database of virtual subdomain addresses and a search and download facility that will extract selected data from the addresses' associated contacts information, load these into the database, and enable for this database to be searched.

WebBIZcontacts joined with virtual subdomain addresses forms a powerful contacts manager. Virtual subdomain addresses enable a brief and preferred address to communicate a person's identity (WebBIZcard); while, WebBIZcontacts enables for the search, retrieval, and storage of WebBIZcards.

### BRIEF DESCRIPTION OF THE DRAWINGS

The figures presented herein when taken in conjunction with the disclosure form a complete description of the invention, wherein elements and steps indicated by like reference indicators are the same or equivalent elements or steps.

FIG. 1 (Prior Art) shows a brief summary of how virtual subdomain addresses (VSAs) work.

FIG. 2 (Prior Art) shows a sample virtual subdomain address (VSA) with its associated contacts information, known as a WebBIZcard.

FIG. 3 (Prior Art) shows how a searchable index of WebBIZcards can be formed.

FIG. 4 shows how a WebBIZcontacts type 1 works.

FIG. 5 shows an embodiment of WebBIZcontacts type 1 with the user's VSAs online.

FIG. 6 shows an embodiment of WebBIZcontacts type 1 with the user's VSAs on a local computing device.

FIG. 7 shows a VSAserver that services VSAs for multiple domains.

FIG. 8 shows how a WebBIZcontacts type 2 works.

FIG. 9 shows a WebBIZcontacts type 2 with VSAs and search facility on a local computing device.

FIG. 10 shows a WebBIZcontacts type 2 with the VSAs and search facility online.

### DETAILED DESCRIPTION

This invention, WebBIZcontacts, is a storage, search, and retrieval environment for virtual subdomain addresses and their associated contacts information used in contacts management.

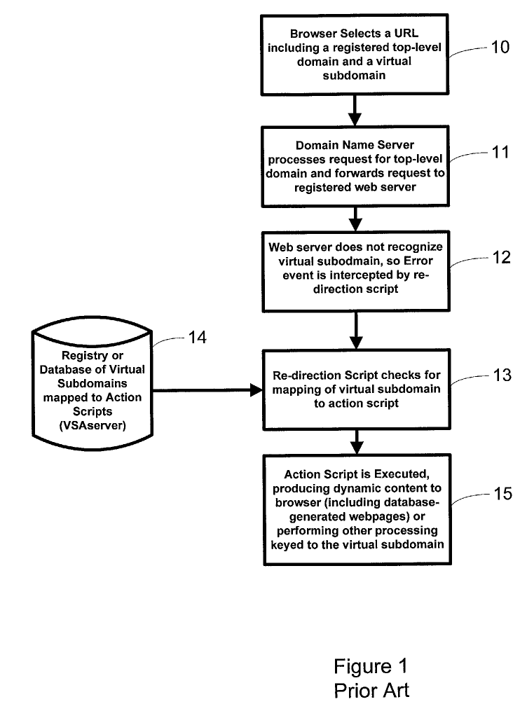

FIG. 1 (Prior Art) shows a brief summary of how virtual subdomain addresses (VSAs) work.

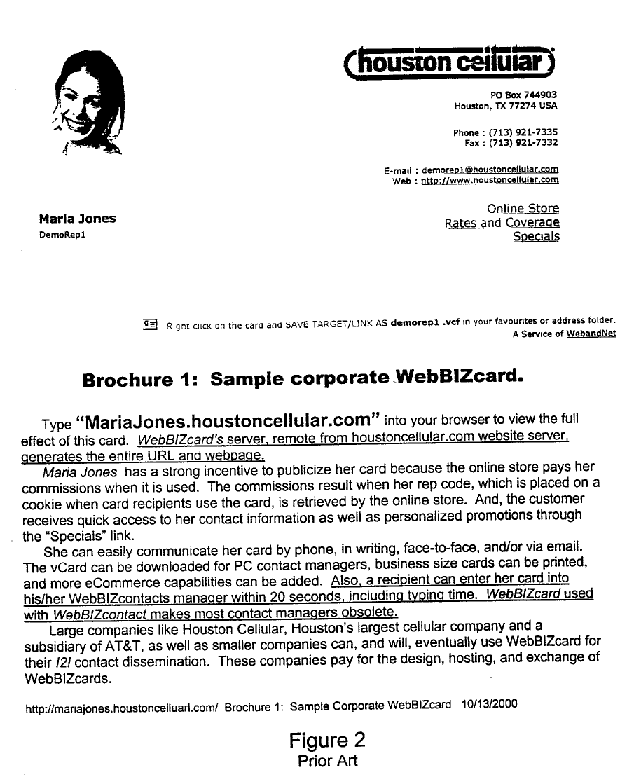

FIG. 2 (Prior Art) shows a sample virtual subdomain address (VSA) with its associated contacts information, known as a WebBIZcard.

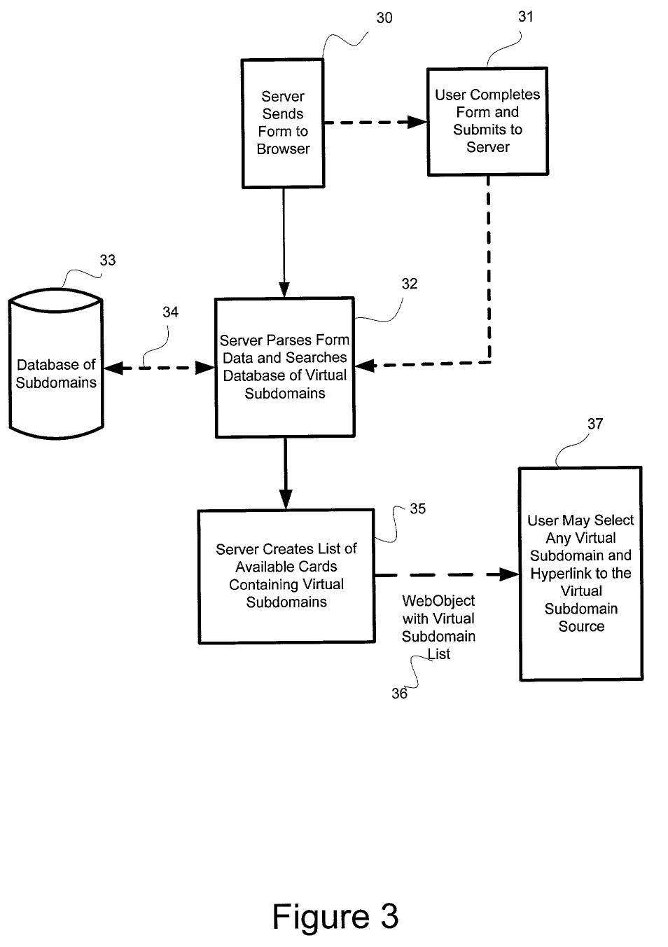

FIG. 3 (Prior Art) shows how a searchable index of WebBIZcards can be formed.

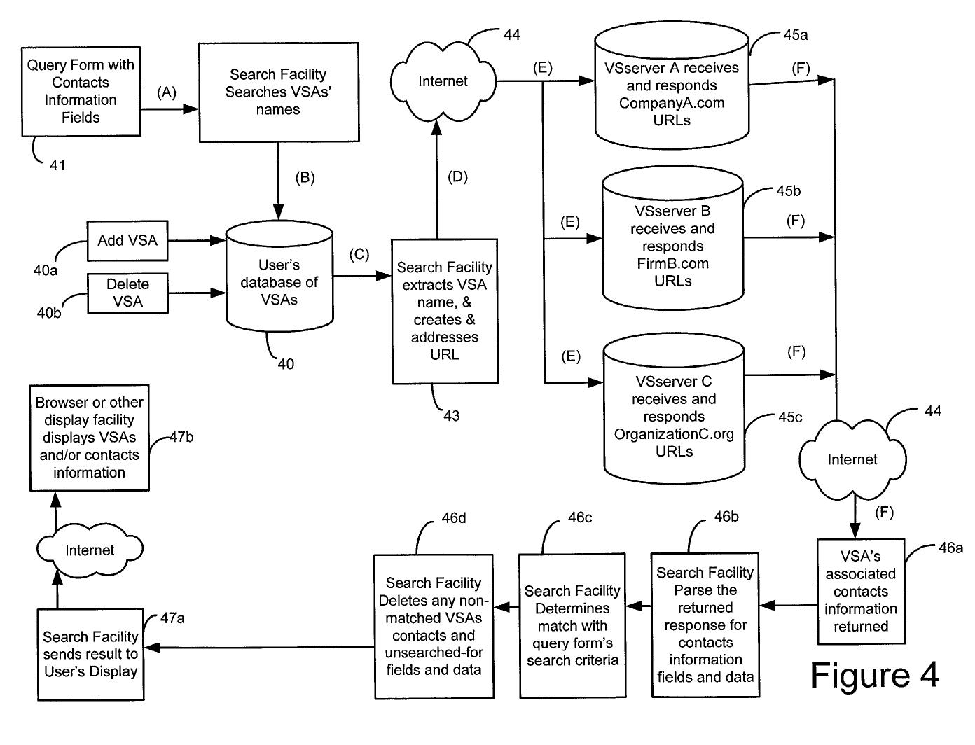

FIG. 4 shows how a WebBIZcontacts type 1 works.

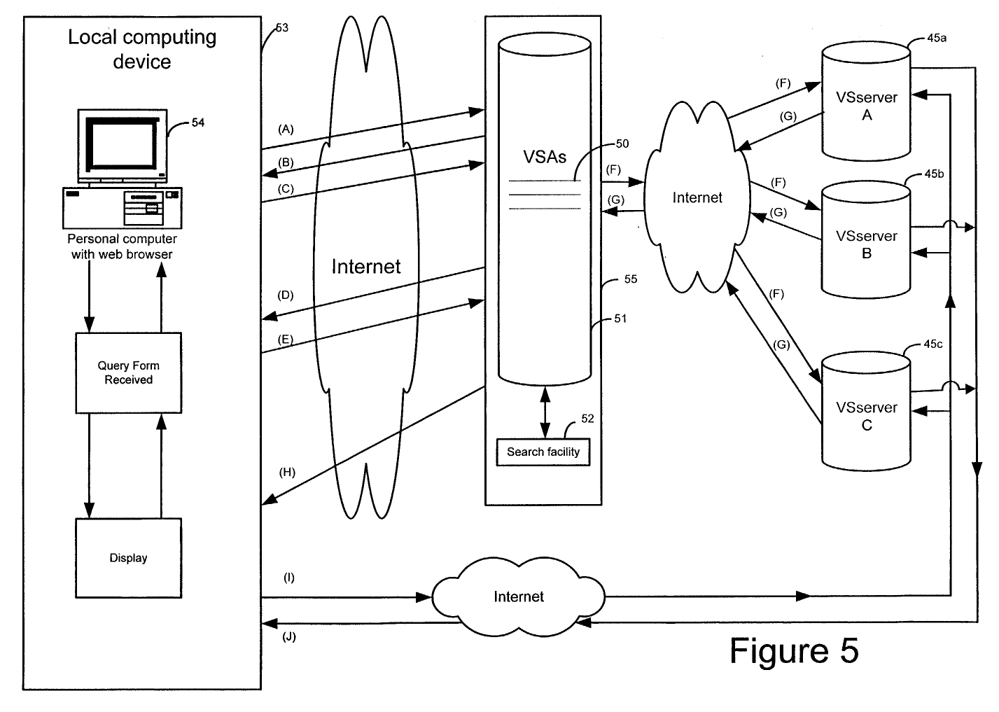

FIG. 5 shows an embodiment of WebBIZcontacts type 1 with the user's VSAs online.

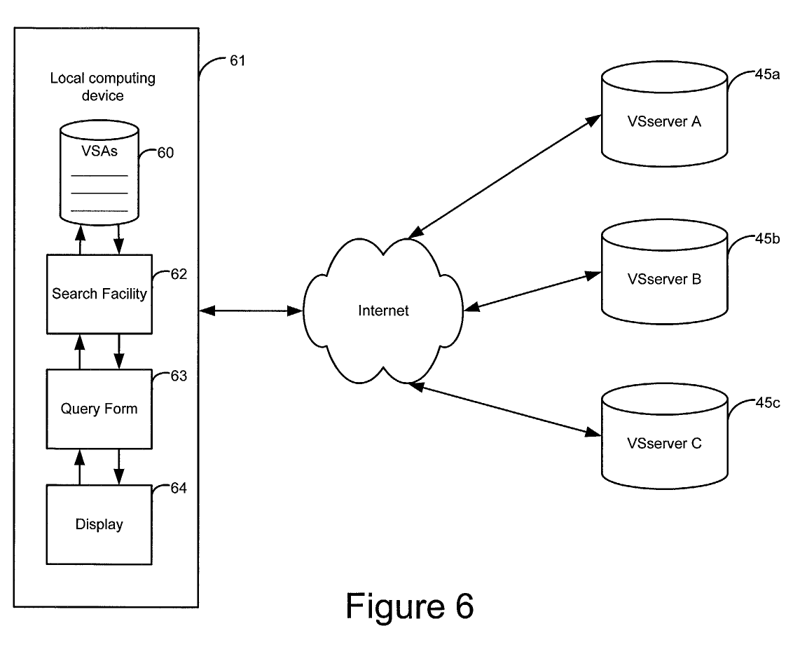

FIG. 6 shows an embodiment of WebBIZcontacts type 1 with the user's VSAs on a local computing device.

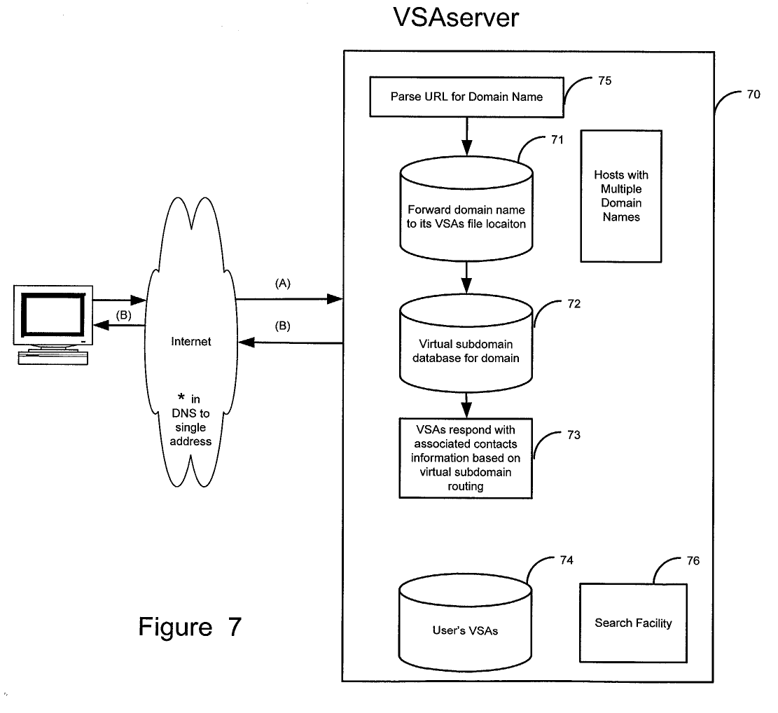

FIG. 7 shows a VSAserver that services VSAs for multiple domains.

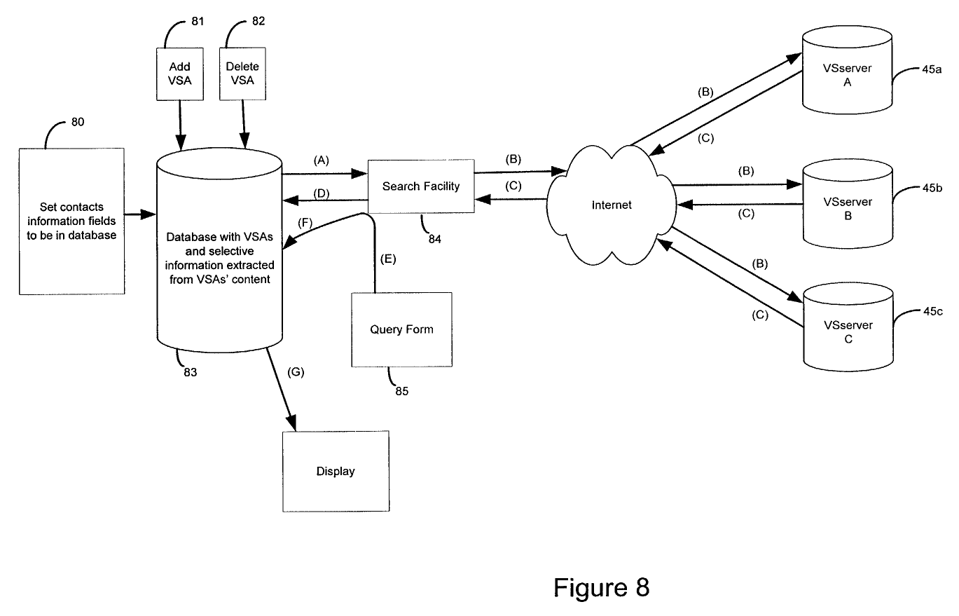

FIG. 8 shows how a WebBIZcontacts type 2 works.

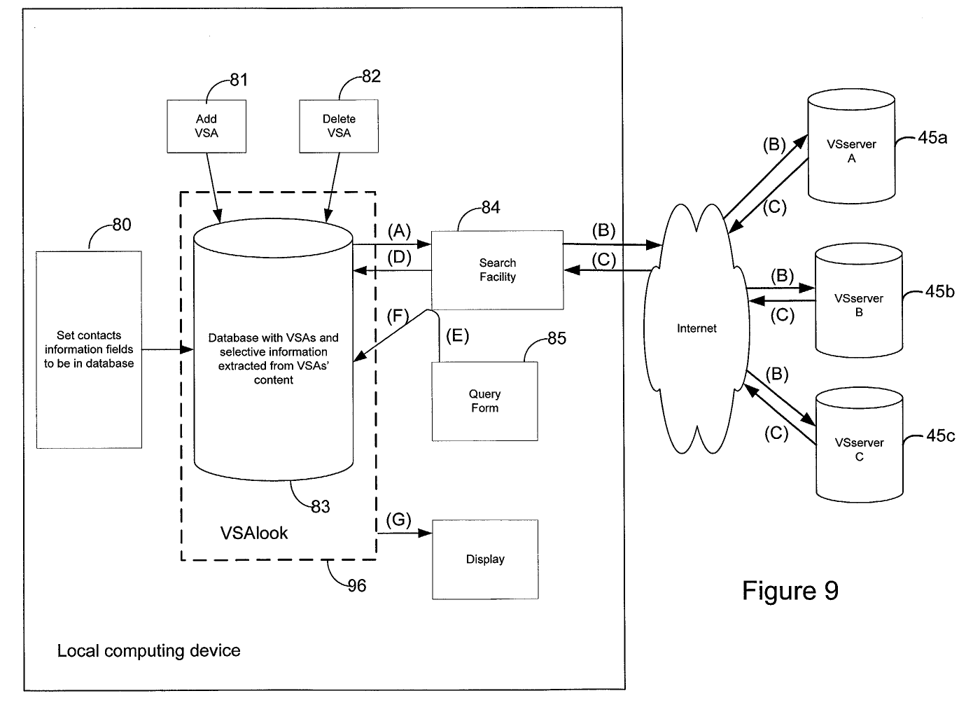

FIG. 9 shows a WebBIZcontacts type 2 with VSAs and search facility on a local computing device.

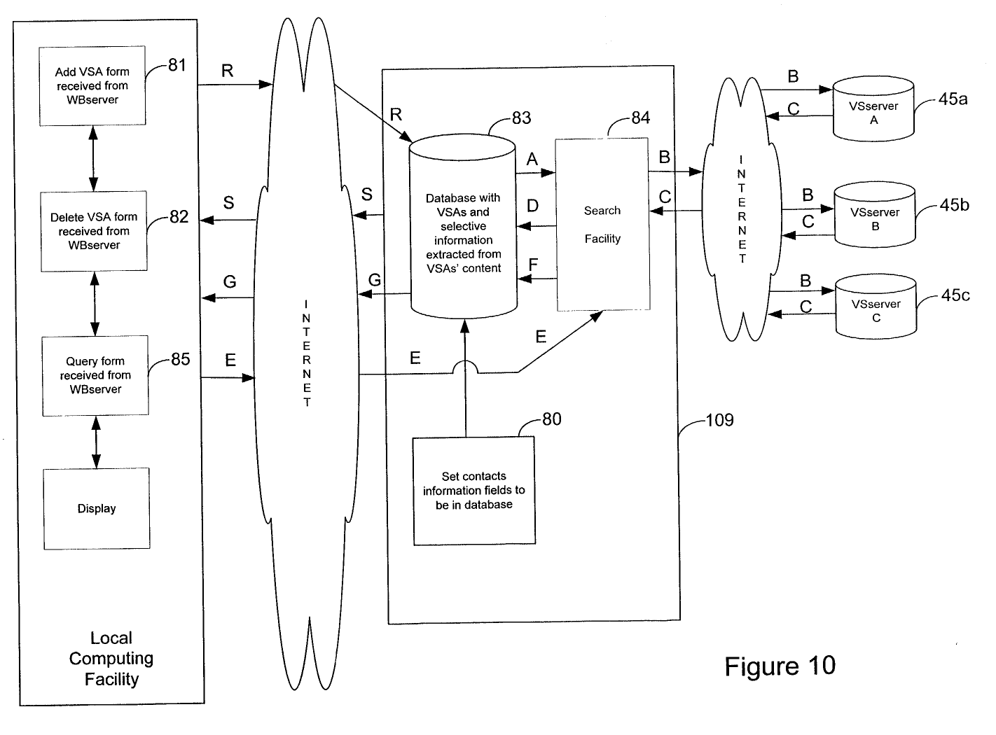

FIG. 10 shows a WebBIZcontacts type 2 with the VSAs and search facility online.

The words “domain”, “subdomain”, “virtual subdomain”, “virtual subdomain address”, “top level domain”, “file suffix”, and others have loose meanings in the industry. Some of these will be defined to help with clarification.

Definitions:

In a URL, “http://ww2.AnyCompany.com/DeptA/AnyPerson”, “http” is the protocol. The “ww2” is the subdomain name and is coupled with “AnyCompany.com”, the domain name. (AnyCompany.com is also frequently referred to as a “second-level-domain” as well as “domain”. In this application, the words “domain” and “domain name” when used as nouns will mean second-level-domains.) “com” is the top level domain name, and “/DeptA/AnyPerson” is the file suffix.

Subdomain names can have names other than “ww2” or “www” (as commonly seen). For examples, it can be “JohnDoe” or “MaryJones” or “Anything.” The subdomain name can reflect a real or virtual subdomain name.

A real subdomain name is created through registering its subdomain name's text in its coupled domain's DNS routing tables. A virtual subdomain name doesn't have the subdomain name's text registered in its coupled domain's DNS routing tables, but its name's text is registered in a VSserver. A virtual subdomain address (VSA) is an address comprising of a virtual subdomain name prefixed in front of a period which is in front of a registered domain name. A virtual subdomain address is not registered in and not recognized by DNS tables, but is registered and recognized by a VSserver.

A virtual subdomain server (VSserver) is a server that receives virtual subdomain addresses or virtual subdomain names, has these addresses or names registered in its database, and processes these. A VSserver can return associated contacts information, webpages, launch web scripts, redirect to an IP address, and perform other computing actions. The workings of a VSserver are described in the below listed Table 3's patent applications. It is not explicitly stated in these applications whether VSserver can simultaneously serve multiple domains. So as to further define, we will use VSAServer (Virtual Subdomain Address Server) as a server similar to a VSserver and can service multiple domains.

A WebBIZcard is a virtual subdomain address that when addressed by a web browser using Hypertext Transfer Protocol (http:) graphically shows a person's contacts information. FIG. 2 (Prior Art) shows one. A WebBIZcard has the person's name or representation of his name as the subdomain name. Though this person's naming doesn't affect the way the technology works, for commercial implementation, it is valuable, because it creates a consistent naming format to be carried across virtual subdomain address business cards. The subdomain name can also be a person's name's representation, as many people have nicknames, may prefer an alias name, and other reasons. A WebBIZdex is an index of WebBIZcards which a user can search for the contacts information of WebBIZcards.

A VSA-URL is a VSA that has http://” added in front of the VSA text and is being used for Internet addressing. A WebBIZcontacts search facility has these computing search capabilities: 1. search in a database and extract the text; 2. use VSA-URL to address the Internet and receive the returned VSA's contacts information 3. parse this returned contacts information and search on its contacts information data fields and other information received; and 4. other general data and database search capabilities.

Unless otherwise noted, the word “address” will refer to the text address of domains and subdomains instead of their IP address, which is a set of four numbers separated by periods. Where a web browser is involved, the Hypertext Transfer Protocol (http) is the assumed protocol, unless otherwise noted.

TABLE 2
Some differences between Real and Virtual Subdomain Addresses

| Real Subdomain Address | Virtual Subdomain Address |
|---|---|
| Subdomain name listed in the DNS | Created virtually without being |
| routing Tables | specifically listed in the DNS |
| Takes longer to become available | tables. |
| when listed or updated in DNS | Becomes instantly available when |
| routing tables. | listed or updated. |
| If real subdomain addresses were | |
| used extensively for subdomains | |
| contacts management, this can | |
| cause large lists of domain DNS | |
| tables to burden the Internet | |
| Sometimes referred to as third- | |
| level-domain | |

The technologies for DNS tables, real subdomains, real subdomain addresses, domains, file suffixes, addressing mechanisms, TCP/IP, IP, HTTP, web browser, and standard URL are well understood by most web programmers and webmasters. Virtual subdomains, VSA, VSserver, and virtual subdomain addressing are briefly explained below. The technologies for these are explained in detail in U.S. applications Ser. Nos. 09/476,632; 09/642,127 filed by Azkar Choudhry; and No. 60/267,943 filed by Chen Sun and Azkar Choudhry. (Table 3)

TABLE 3
Prior Patent Applications on VSA technologies

| Patent | |
|---|---|
| Application | |
| Number | Patent Title |
| 09/476,632 | System and Method for Dynamic Creation and Management |
| | of Virtual Subdomain Addresses |
| 09/642,127 | System and Method for Interactive Data Services Using |
| | Virtual Subdomain Addresses |
| 60/267,943 | Organizing and Accessing Electronic Business Cards by |
| | Virtual Subdomain |

FIG. 1 (Prior Art) shows in an example of a technology used to create 1) a VSA, 2) a VSA which launches a smart script, and 3) a VSA index. This technology was used for patent applications Ser. Nos. 09/476,632, 09/642,127, and No. 60/267,943. When a user submits a URL with a VSA through his browser (10), a Domain Name Server processes the top-level domain and forwards the request to the registered web server (11). Because the real subdomain doesn't exist, the domain's web server returns an error message (12). The error message is intercepted (12), and then the VSA request is further processed by a VSserver (13 & 14). In this case, the VSserver parses the VSA request, analyzes the subdomain name to process an associated computing script and returns a dynamically-generated webpages to the user's browser (15). Thus, the user's sees the webpages of a VSA.

Another example technology would be where the web server does not generate an error signal upon receiving a VSA, but instead automatically forwards the file-not-found-condition of the VSA to a pre-assigned IP address. This IP address can hold a VSserver that can parse the URL, and return a virtual-subdomain-address-specific web page to the initial request.

A third example technology would be similar to above with a VSAServer that parses the URLs for multiple domain names.

FIG. 2 (Prior Art) is an example of a WebBIZcard (VSA generated webpage) using the domain name HoustonCelluar.com. In response to the VSA request “MariaJones.HoustonCellular.com” the VSserver supplies the web format of the shown card with the subdomain-named individual's contacts-information—in this case, the associated business card contacts information for Maria Jones. This type of VSA and its associated business card content web page is called a WebBIZcard, a form of web business card; hence, WebBIZcontacts can hold WebBIZcards. A web business card using VSA can contain more contacts information than as seen in FIG. 2, and can include the contacts information types mentioned in the Background section of this patent application. Display devices that show the VSAs and associated contacts information include web browser for computers, kiosks, handheld computers, or any computing-related-Internet-accessible device that can display the text of a URL and/or contacts management information.

FIG. 3 (Prior Art) is taken from Patent application No. 60/267,943, “Organizing and Accessing Electronic Business Cards by Virtual Subdomain” where it shows that an index of such VSA cards can be made. Essentially, a user can register for a virtual subdomain address with the VSserver and then input in his contacts information through a browser. The VSserver keeps these information in its database and when the user's virtual subdomain address is requested, generates a web business card to respond to the requester. This database can store many subdomains and create an index of web business cards.

“Turning to FIG. 3, the WebBIZdex web server script for providing a searchable index of online business cards transmits (30) to the web browser user a form to collect information on which to find business cards. This form may be sent to the web browser using a CGI type form or other type form such as a Java form. The user completes the form and submits (31) it to the WebBIZdex server.

The form data is received by the web server script and parsed (32) to create a database search query. However, unlike systems of current technology, this database query string is never visible to or provided to the user. The search query (34) is answered by the database by returning one or more records containing the data requested by the search query including one or more virtual subdomain addresses.

The server script creates (35) a list of available business cards comprised of multiple virtual subdomain entries, such as “john.collegealum.edu”, and transmits this list to the web browser user. The web browser user may then simply hyperlink (37) or select any of the virtual subdomains, which will activate the process described in the related application where the virtual subdomain server intercepts the request for the unregistered virtual subdomain name and translates it to an actual web address. At this actual web address may be any web object, such as an electronic business card.”

VSservers can be added to other domains; for examples, CompanyA.com, FirmB.com, and OrganizationC.org can each have a VSserver and serve up their own VSA cards. To explain the invention, four VSAs with associated contacts information are listed in Table 4 and will be used throughout this document.

TABLE 4
Examples of VSAs with Associated Contacts Information

| | Contacts | Contacts | Contacts | Contacts | |
|---|---|---|---|---|---|
| | Information | Information | Information | Information | Contacts Information |
| Stored VSAs | Organization | First Name | Last Name | Occupation | email |
| Bob.CompanyA.com | Company A | Bob | Smith | Accountant | bob@companya.com |
| Mary.CompanyA.com | Company A | Mary | Jones | Lawyer | mary@companya.com |
| Bob.FirmB.com | Firm B | Bob | Johnson | Accountant | bob@firmb.com |
| Janet.OrganizationC.org | Organization C | Janet | Roth | Preacher | janet@organizationC.org |

WebBIZcontacts, Type 1

FIG. 4 shows the invention, a WebBIZcontacts type 1. This WebBIZcontacts has a database of user's stored VSAs, query search form, and search facility that can search, using the Internet, for the VSAs' associated contacts information.

We can see the methodology and components of this invention through an example and using the VSAs in Table 4. The user has the three VSAs in his personal VSAs database (40): Bob.CompanyA.com, Mary.CompanyA.com, Bob.FirmB.com. He adds (40a) a VSA by typing in Janet.OrganizationC.org into his database. Of course, he can delete (40b) any of the VSAs.

To search, user receives a query search form (41) with search fields. In this example, the search fields include “Organization”, “First Name”, “Last Name”, “Occupation”, and “email”. Other query search forms may have different search fields. The user searches for “Accountant” in the “Occupation” field. (Table 5)

TABLE 5
Sample Query Search Form, Search Fields, and
“Occupation” Search

| | | | | | |
|---|---|---|---|---|---|
| | | First | Last | | |
| Query | Organization | Name | Name | Occupation | email |

Accountant

A search facility would then extract (B & C) the text of the user's stored VSAs (40) and form a URL (43), one way by simply attaching http:// in front of any of the stored VSAs. WebBIZcontacts' search facility then uses VSA-URL to address (D) the Internet (44) and access one VSserver. CompanyA.com is serviced by VSserver A (45a); FirmB.com, VSserver B (45B); and OrganizationC.org, VSserver C (45C).

When VSA-URLs are addressed, DNS would route (E) the VSA's URL request to the appropriate domain. VSA technology (as explained in Table 3's patent applications) would then enable the appropriate VSserver to receive its VSA or its subdomain name. Subsequently, the VSserver would respond (F) with, the VSA's associated contacts information. Details of this routing process and VSservers responses are explained in Table 3's patent applications.

Upon receiving the response (46a), the user's search facility then parses it (46b) and determines whether the response contacts information meet the search criteria (46c). It deletes any non-matched VSAs and deletes any unnecessary fields information (46d) in these VSAs. Then it sends results to user's display (47a) which can display a list of matching VSAs and/or their associated contacts information (47b).

In this example, when searching for “Accountant”, user receives Bob.CompanyA.com and Bob.FirmB.com (and/or their associated contacts information) (Tables 6& 7)

TABLE 6
Results Displayed on Browser as VSAs
Bob.CompanyA.com
Bob.FirmB.com

TABLE 7
Results Displayed on Browser as VSAs with associated
contacts information.

| | | | | | |
|---|---|---|---|---|---|
| Bob.CompanyA.com | Company A | Bob | Smith | Accountant | bob@companyA.com |
| Bob.FirmB.com | Firm B | Bob | Johnson | Accountant | bob@firmB.com |

Major embodiments are described below. The primary differences among these involve: 1. where the VSA are stored—local to the user or accessed online, 2. will it be a single VSAServer handling the virtual subdomains for numerous domains or several VSservers handling the virtual subdomains for their respective domains, 3. where is the search facility—within or independent of the VSserver, and 4. how is the communications transferred between WebBIZcontacts search facility and VSservers?

Preferred Embodiment of Type 1—VSAs Online (FIG. 5)

In the preferred embodiment, the user's VSAs (50) are stored on a web database (51) that the user has password access to. The preferred web server used would be alike those in Table 3's patent applications—Apache web server on Linux operating system. The preferred user personal computer (54) uses Microsoft Windows 98 and the web browser Microsoft Internet Explorer. Other local web client computing devices such as handheld computers and kiosks and other web servers are also acceptable (53). Both the web server and personal computer are connected to the Internet. The web server, VSA database, and search facility together is called WBserver (55).

In this embodiment, the user uses a browser (54) to Internet access (A) his web VSA database. The WBserver (55) responds (B) by sending a display of the user's stored VSAs as URL links in his browser. The user can select a VSA-URL link to see full contacts information, or he can search on these VSAs.

Should the user searches (C), the WBserver (55) responds (D) with a CGI or Java web form with contacts information fields for searching (Table 3). Using his keyboard, the user inputs the search criteria, and submits (E) the form. The WBserver receives this search request, reads each of the user's stored VSAs (50), and Internet addresses (F) using the VSA-URL (e.g., htt://VSA). The appropriate VSserver (45a, 45b, or 45c) responds (G) with the VSA's contacts information sent to the WBserver. The WBserver search facility (52) parses and searches this contacts information to determine whether it meets the search criteria. WBserver then sends (H) matching VSAs to the user's personal computer as a list of VSAs. The user can then click (I) the VSA to activate the hyperlink that enables him to see (J) the VSA's associated contacts information on his browser.

Query search standards will be set between WebBIZcontacts' search facility and the VSserver. The preferred method here is to use HTML comment tags “<—!comment!>”, with the comments set as “data field descriptors”. For example, if WBserver (55) addresses VSA BobSmith.CompanyA.com, CompanyA.com's VSserver responds by sending Bob Smith's contacts information attached with comments that serve as field descriptors—“contacts information data <!—its data field descriptor—>” as below:

Bob <!—FirstName—>;

Smith <!—LastName—>

CompanyA <!—CompanyName—>

Accountant <!—Occupation—>

email <!—email—>.

By using these comments like data field descriptors the search facility can search on contacts information data. Comment fields are advantageous because WBserver and browser can both address the same VSA-URL, and the former receives and manipulates on the data field descriptors, while the browser doesn't display the commentaries.

Alternative Embodiment of Type 1—VSAs Local (FIG. 6)

In a second embodiment, the user's VSAs are located in a searchable database (60) on his personal computer or other local computing devices (61), instead of on a web server. His personal computer runs Microsoft's Windows 98 operating system and Microsoft's Internet Explorer and is connected to the Internet. Again, the VSservers preferably run Apache web server on Linux, as described in Table 3's patent applications. There are three VSservers in FIG. 6, one for CompanyA.com, one for CompanyB.com, one for OrganizationC.org, all connected to the Internet.

When the user uses the query search form (Table 5) (63), the search facility (62) would extract each of the personal computer's database's VSAs (60), create a VSA-URL, and address their VSservers. The VSservers would return VSAs' contacts information and search facility would determine which meet the search criteria. The results would then be displayed on a browser (Table 6 and 7) (64).

Alternative Method on Transfer of Contacts Information Data #1

A more elegant, but perhaps more difficult to implement method, is that the VSservers and WebBIZcontacts search facility communicate through using extended markup language (XML), instead of the HTML commentaries above. XML is an evolving standard that can identify data types. For example, when a VSA request for BobSmith.CompanvA.com is made, the VSserver returns XML like the following.

<PERSON>

<NAME>

<FIRST>Bob</FIRST>

<LAST>Smith</LAST>

</NAME>

<COMPANY>CompanyA</COMPANY>

<OCCUPATION>Accountant</OCCUPATION>

<EMAIL>bob@companyA.com</EMAIL>

</PERSON>

The search facility can now examine the “Occupation” field and determine whether it contains “Accountant”, and then send the VSA and/or its contacts information to the user's browser.

Alternative Method on Transfer of Contacts Information Data #2

Another standard to transfer contacts information between VSservers and WebBIZcontacts search facility can be that the VSservers will release only standardized data fields, for examples, only First Name, Last Name, and Company information, and the WebBIZcontacts search facility will only search on these standards. Hence, if the VSAs' HTML responses for the various VSservers have identical formats, the receiving WebBIZcontacts search facility can parse out the various contacts information fields and process these to determine which fields meet the search criteria.

Alternative Method on Transfer of Contacts Information Data #3

A programming routine that the VSserver generated vCards using VSAs' contacts information was included with the patent applications of Table 3. A vCard is a standard data format that many contacts manager use to transfer contacts information. In the program routine, when a user requests a VSA, his browser displays its contacts information with a vCard download link. When the user clicks the link, the VSserver generates a vCard data format file from the VSA's contacts information and downloaded this vCard to the user's Microsoft Windows98 desktop. The vCard can then be imported into a standard PC-based contact manager, like Microsoft's Outlook. Microsoft Outlook can then search on the contacts information. Once again, this shows a VSserver can transfer its contacts information to the user in an organized manner that is searchable.

Alternative Embodiment: VSAserver Host and Coupled with Multiple Domain Names (FIG. 7)

In this embodiment, the VSservers are located on a single host computer, instead of being located on different host computers or servers. This is possible because, as explained by Table 3's patent applications, VSservers receive their VSA-URL requests when the virtual subdomain name is not found in their associated domain's DNS routing tables, and the URL request is forwarded to the VSservers by a “*” entry in the domains' routing tables. In this embodiment, all the domains' “*” entries' IP addresses are pointed to a single host computing server (A). To better clarify, we again define VSAServer (70) as a single host computer that serves multiple domains' virtual subdomain addresses.

Upon receiving the VSA-URL, the VSAserver can parse (75) the request to determine the VSA's domain name. The VSAserver then has translation tables that use the domain name to forward (71) the VSA-URL request to the domain's virtual subdomain database (72), also on the same host server computer. After inquiring in this virtual subdomain database, the respective contacts information are subsequently retrieved and sent (B) to the user's browser.

If the user's VSAs (74) and search facility (76) were also on the VSAserver, this would be significantly faster, as much of the searching takes place on a single host computer, rather than multiple accesses through the Internet. This last paragraph is not part of our provisional application but is included here for fuller and better explanation and disclosure.

Alternative Embodiment—Search Facility on VSserver Instead of on Users Website or Local Computing Facility

In previous embodiments, the WebBIZcontacts search facility is local to the originating user's website or on the user's local computing facility. However, it is possible that the search facility is on the VSserver. Contacts information fields' data may be transferred much like as in a CGI form request—using http requests with variables in the URL file suffix. The user can post variables, and VSserver return information. Here the virtual subdomain file suffix technology is implemented in an upcoming patent application. Hence the search facility can also be on the VSserver or VSAserver. This embodiment is not part of our provisional application but is included here for fuller and better explanation and disclosure.

WebBIZcontacts Type 2

FIG. 8 shows a second type of WebBIZcontacts. This WebBIZcontacts has its own searchable database (83) where each record includes a VSA field and selected fields of the VSA's associated contacts information. The selected fields of contacts information are previously set (80). A user first populates his WebBIZcontacts' database (83) by adding (81) and deleting (82) VSAs into the database's VSA field, such as by manual typing entry of the VSA or through automated data import of the VSAs. The search facility (84) acquires (A) the newly added VSAs names from the database, adds “http://” to the VSAs to form URLs, Internet addresses (B) the VSA-URLs, and receive (C) the associated contacts information from the VSservers (45a, 45b, 45c). The search facility then extracts the selected fields' data and saves (F) the data into the database (83). The data communications of fields information between the search facility and VSservers is accomplished by HTML commentaries, XML, vCard format, and other methods previously described.

In having its own local database, WebBIZcontacts type 2 can usually search much faster than an Internet access search to a VSserver, as in type 1.

For example, user's database and search facility have “First Name”, “Last Name”, and “Company” as selected contacts information fields. The owner of WebBIZcontacts previously set these fields (80). The user enters VSAs Bob.CompanyA.com, Bob.FirmB.com, and Mary.CompanyA.com (81) into the database.

The search facility (84) retrieves (A) the newly stored VSAs, uses the VSAs to address (B) the Internet and VSservers and receives (C) the VSAs' contacts information. The search facility extracts data from the VSA's First, Last, and Company Name fields and saves (D) these into a database's record along with their associated VSA. Using the VSAs of Table 4, the stored information in this WebBIZcontacts database (83) would be, as in Table 8:

TABLE 8
WebBIZcontacts's VSAs with selected contacts in formation fields'
data

| | First | Last | |
|---|---|---|---|
| VSA | Name | Name | Company |
| Bob.CompanyA.com | Bob | Smith | Company A |
| Bob.FirmB.com | Bob | Johnson | Firm B |
| Mary.CompanyA.com | Mary | Jones | Company A |

Now, a query search (85) for “CompanyA” would search (E) locally (F) and display Bob.CompanyA.com and Mary.CompanyA.com (G) faster than through a search accessed through the Internet (as in WebBIZcontacts type 1). Tables 9 and 10 shows this WebBIZcontacts type 2 search

TABLE 9
Query search form

| First | Last | |
|---|---|---|
| Name | Name | Company |
| | | Company A |

TABLE 10
Search Results of WebBIZcontacts type 2 with VSAs local

| | First | Last | |
|---|---|---|---|
| VSA | Name | Name | Company |
| Bob.CompanyA.com | Bob | Smith | Company A |
| Mary.CompanyA.com | Mary | Jones | Company A |

Embodiment of WebBIZcontacts Type 2—VSAs Local (FIG. 9)

For this embodiment, a VSAlook is defined to be a local contacts management software that contains a database field for virtual subdomain address and this field can hyperlink to Internet access the VSA. For example, Microsoft Outlook has a “Website Page Address” field that hyperlinks, Internet addresses, and launches a browser webpage. Ideally, Microsoft Outlook would also have a “Virtual Subdomain Address” field that also hyperlinks, Internet addresses, and displays VSA's webpage(s). Outlook, ACT, Goldmine, are some contacts manager software that, if these included a VSA-Internet-access-hyperlink-database-field, would work well as a VSAlook.

In this embodiment, a VSAlook (96), a WebBIZcontacts type 2's VSAs' database (which may be same as or part of VSAlook database) (83), search facility (84), query form (85), and add and delete VSA boxes (81 & 82) reside on a user's personal computer or other local computing device. This personal computer preferably runs Windows 98 operating system, Internet Explorer, and has Internet access. The search facility, query form, and add and delete VSA boxes, and WebBIZcontacts type 2 VSAs database may be incorporated in the VSAlook.

As in type 1 embodiments, the user enters (81) VSAs into the VSAs' database (83) through keyboard entry, mouse copy and paste, and other means. Search facility (84) then addresses (B) the Internet using these VSAs and downloads (C) the VSAs' associated contacts information.

Unlike the type 1 embodiments, the search facility (84) next extracts the data from selected fields of the downloaded contacts information. It searches and extracts by HTML commentaries, XML, vCard, and other means previously discussed. Then the data is saved (D) into the respective WebBIZcontacts database fields (83) along with their respective VSAs. Query form (85) can then search (E,F) the VSAs' selected contacts information, without requiring Internet access.

To further explain, let's start with a VSA-vCard download to a popular personal-computer contact manager. A user requests through his browser a VSA. Table 3's patent applications included programming code such that when a user requests a VSA, the VSserver responded with a webpage with associated contacts information and a vCard download link. When a user activates the link, the VSserver would generate a vCard from the VSA's contacts information. This vCard information is downloaded onto the Windows desktop, and imported to a personal computer contact manager, as Microsoft Outlook.

In this embodiment example, the VSA generates a vCard and a VSA name, and both are downloaded. If desired, the search facility searches for relevant fields in the vCard. The relevant vCard fields' data and VSA name are then imported into VSAlook with the VSA name going into a database field that can hyperlink Internet access. User query (85) can then be made locally (E,F) for selected VSA information, instead of accessing the Internet.

HTML commentaries and XML with the search facility can also be used, instead of vCard download, to deliver information to the VSAlook. The selected contacts information are stored in the same record as their respective VSAs.

In having the VSAs, VSAlook can add computing routines to regularly update its contacts database with current VSA contacts information. Because a VSA can have more varieties of information, better graphical information, and greater levels of security access than a local contacts manager's contact record (e.g. Outlook's person's contact record), the VSAlook's user gains better information.

Though it is preferred that the VSA name is imported into a field that can hyperlink Internet access, this isn't necessary. As long as the VSA name is imported into the database, it can be extracted and used as a VSA-URL to address VSA contacts information.

Preferred Embodiment of WebBIZcontacts Type 2 with VSAs Online (FIG. 10)

In the preferred embodiment of type 2, the WebBIZcontacts VSAs and its selected contacts information are online and the user sees his VSAs as URL links in his browser.

When he accesses his WebBIZcontacts type 2online, the user receives from the WBserver (109) access to his database of stored VSAs with selected contacts information (83). He also receives on his browser a enter data box, sent by WBserver, where he can “Add VSA” (81). He enters and submits (R) his VSAs, and WBserver stores (R) these into the database.

As previously described for FIGS. 8 and 9, the search facility (84) uses (A) these VSAs as Internet URL addresses (by prefixing http://) and requests (B) VSAs' associated contacts information from the VSservers (45a, 45b, 45c). The search facility is preset to select data from specified contacts information fields. The VSservers respond (C) with contacts information, and the search facility removes non-searched fields and data. The search facility then saves (D) selected contacts information data and their respective VSA into the database (83). The VSA contacts information fields can be detected by the various methods described previously, including XML, HTML commentary fields associated with the data, consistent format, and others.

When the user wishes to search his database, the WBserver sends (S) his browser a query search form (85), and he inputs. The query search form is then transmitted (E) to search facility (84), which then searches (F) his database (83). Search results consisting of selected VSA contacts information and respective VSAs are returned (G) to the local computing facility. Using this embodiment, the user then can search faster than having to access the Internet and contacting each domain's VSservers for contacts information.

For example, user has a personal computer running Windows 98 connected to the Internet. Apache-Linux web servers serve the WBserver and the VSservers. Using a browser, user accesses the website containing his VSAs, and receives “add VSA” box entry (81) sent by the WBserver. The user submits (R) VSAs Bob.CompanyA.com, Bob.FirmB.com, and Mary.CompanyA.com. WBserver receives and adds these into the database (83).

Then, the search facility (84) extracts (A) and prefaces http:// to these VSAs to use to address (B) their respective VSservers (45a, 45b). The VSservers respond (C) with the information in Table 11. The search facility extracts the First Name, Last Name, and Company fields' data, discards the remaining fields and data, and saves the extracted fields data into the database (83) with their VSAs, as in Table 12.

TABLE 11
VSserver returns contacts information

| | | | | | |
|---|---|---|---|---|---|
| Bob.CompanyA.com | Company A | Bob | Smith | Accountant | bob@companya.com |
| Mary.CompanyA.com | Company A | Mary | Jones | Lawyer | mary@companya.com |
| Bob.FirmB.com | Firm B | Bob | Johnson | Accountant | bob@firmb.com |

TABLE 12
VSA and selected contact fields' data are stored into database

| | | | |
|---|---|---|---|
| Bob.CompanyA.com | Company A | Bob | Smith |
| Mary.CompanyA.com | Company A | Mary | Jones |

When the user wishes to search his database, the WBserver sends (S) him a query search form (85), and, in this example, he specifies “CompanyA” in the Company field. The form is returned (E) to WBserver, which then searches (F) its database (83). The results in Table 13 are returned (G) to the user.

TABLE 13
Results of search for “CompanyA”

| | | | |
|---|---|---|---|
| Bob.CompanyA.com | Company A | Bob | Smith |
| Mary.CompanyA.com | Company A | Mary | Jones |

Minor Variants

There are many ways to add or delete a VSA to its stored database. One way is to simply type in the VSA into the database. Another way is to copy and paste a VSA. A third way is to use a data import of the VSA. The VSAs can also be located in a palmtop or kiosk and use a different kind of Internet client than a web browser. The operating system of the servers can change to Microsoft's Windows NT Server, the web server can change to Microsoft's Internet Information Server. Other operating systems and web servers can be used. Users' operating system may be other versions of Windows as well as non-windows operating systems. Other data fields can be added to the database—for example, there can be a field for user notes that he types in about the contact. In still other embodiments, add-on applications may be used to expedite data transmissions.

Where the words “personal computer” or “local” are used, these can represent workstations that are part of a local area or wide area network. Here, instead of accessing VSAs on a local hard disk, VSAs may be on the network's hard disk. The technologies for local and wide area networks are well understood, and the terminologies above, when referred to as local, applies to the technologies of these local and wide area network devices.

Physical location of the various components may also differ. For example, it sometimes make very little difference whether the routine that generates the “Add VSA” box comes from a web server or a personal computer.

Security Measures

Security controls can also be set by the VSservers. Such security controls, will be described in detail in a subsequent patent application. Essentially, the owners of the VSA and VSserver will determine how much information he is willing to release to those requesting.

For example, suppose user requests for Name, Occupation, Organization, and email address from the VSservers. The VSserver for CompanyA releases all requested information for Bob.CompanyA.com and restricts email information for Mary.CompanyB.com. Password security at the VSserver may be necessary—such that different codes enable the requesting WebBIZcontacts search facility to receive different selected contacts information.

In summary, there are two types of WebBIZcontacts. One stores VSAs in a database that when searched, use its VSAs to retrieve contacts information on the Internet. The second had already selectively extracted the VSAs' contacts information from the Internet and stored this information data into a local searchable database.

The result is that a contacts management system for storing, searching and retrieving VSAs that are used for contacts management, which can use multiple domain names.

Attachment 1 is a draft copy of my initial attempt to write this patent. It was written to be more of a business method patent. Attachment 2 is two tables that additionally help to explain the advantages of WebBIZcontacts.

While the disclosure contained herein has set forth a preferred embodiment of the invention, and many of the fundamental components used within the invention are well known within the art, it will be appreciated by those skilled in the art that variations to the combination of elements and steps disclosed can be made without departing from the scope and spirit of the invention.

1) A contacts management system comprising of
a plurality of virtual subdomain addresses with:
i) differing domain names, and
ii) each of said virtual subdomain addresses has a person's name or representation of his name as part the subdomain name, and
iii) each of said virtual subdomain addresses when addressed using the hypertext transfer protocol of an Internet-connected web browser displays said person's associated contacts information on said browser, and
a data repository that stores said virtual subdomain addresses, and
an Internet data communications path, and
a computing display facility for said virtual subdomain addresses and/or associated contacts information,
whereby a user can quickly store his contacts' information using virtual subdomain addresses of differing domain names, see the person's name on these subdomain addresses, activate these addresses to send to the Internet, and receive the addresses' contacts information.

2) The contacts management system as set forth in claim 1 further including
A virtual subdomain address server that receives said virtual subdomain address or said virtual subdomain address's subdomain name, and returns said virtual subdomain address's associated contacts information to the sender through the Internet,
whereby the person's contacts information can be served by a server and located by a virtual subdomain address.

3) The contacts management system as set forth in claim 1 further including
a search facility that can query the text of said data repository's virtual subdomain addresses' names, determine which names meet the search's criteria, and present for display the virtual subdomain addresses and/or associated contacts information that meet the search criteria,
whereby the user can conduct a text search of the stored virtual subdomain addresses names.

4) The contacts management system as set forth in claim 2 further including
a search facility that can query the text of said data repository's virtual subdomain addresses' names, determine which names meet the search's criteria, and present for display the virtual subdomain addresses and/or associated contacts information that meet the search criteria,
whereby the user can conduct a text search of the stored virtual subdomain addresses names.

5) The contacts management system as set forth in claim 1 further including
a search facility that can query said data repository's virtual subdomain addresses' associated contacts information, determine which addresses meet the search's criteria, and present for display the virtual subdomain addresses and/or their associated contacts information that meet the search criteria,
whereby the user can conduct a search on the content associated with the virtual subdomain address.

6) The contacts management system as set forth in claim 2 further including
a search facility that can query said data repository's virtual subdomain addresses' associated contacts information, determine which addresses meet the search's criteria, and present for display the virtual subdomain addresses and/or their associated contacts information that meet the search criteria,
whereby the user can conduct a search on the content associated with the virtual subdomain address.

7) The contacts management system as set forth in claim 1 further including
a facility that can receive selective data from the associated contacts information of said virtual subdomain address, and
said data repository contains a database containing a field for said virtual subdomain address and containing fields for said selective data received, and
a search facility to query on said repository and/or database, determine which contacts information in said database meets the search's criteria, and present for display virtual subdomain addresses and/or associated contacts information that meet the search criteria,
whereby the user can conduct a faster database search through its own, usually local, database rather than having to access the Internet for each virtual subdomain content search.

8) The contacts management system as set forth in claim 7 further including
A virtual subdomain address server that receives said virtual subdomain address or said virtual subdomain address's name, and returns the virtual subdomain address's associated contacts information to the sender through the Internet,
whereby the person's contacts information can be served by a server and located by a virtual subdomain address.

9) The contacts management system as set forth in claim 7 wherein
Said search facility can query said data repository and/or database when the system is without Internet access,
whereby the user can use the system without its Internet access.

10) The contacts management system as set forth in claim 8 wherein
Said search facility can query said data repository and/or database when the system is without Internet access,
whereby the user can use the system without its Internet access.

11) A method to manage contacts information comprising of the following steps
providing a plurality of virtual subdomains addresses with:
i) differing domain names, and
ii) each of which has a person's name or representation of his name as part of the subdomain name, and
iii) each of said virtual subdomain addresses when addressed using the hypertext transfer protocol of an Internet-connected web browser displays said person's associated contacts information on said browser, and
providing a computing data repository that stores said virtual subdomains addresses, and
providing a computing display device that can display said virtual subdomain addresses and/or associated contacts information, and
storing said virtual subdomain addresses in said data repository,
whereby a user can quickly store his contacts' information using Internet addresses of differing domain names, and see the person's name on these subdomain addresses.

12) The method to manage contacts information as set forth in claim 11, further including the below steps added after step “storing said virtual subdomains in said data repository”:
providing a data communications access to the Internet, and
selecting and sending said stored virtual subdomain addresses to the Internet, and
receiving in return said selected virtual subdomain addresses' associated contacts information, and
displaying said selected virtual subdomain address and/or associated contacts information,
whereby the person's contacts information can be located and retrieved by a virtual subdomain address.

13) The method to manage contacts information as set forth in claim 12, further including the below steps added after step “selecting and sending said stored virtual subdomain addresses to the Internet, and”:
a) providing a virtual subdomain address server that receives said virtual subdomain address or said virtual subdomain address's subdomain name, and processes and sends through the Internet virtual subdomain address's associated contacts information, and
b) receiving the said selected virtual subdomain addresses by said virtual subdomain address server, and said server sending out said selected virtual subdomain addresses's associated contacts information, and

14) The method to manage contacts information as set forth in claim 11, further including the below steps added after step “storing said virtual subdomains in said data repository”:
providing a text search facility, and
querying the text of said virtual subdomain addresses names using the search facility, and
determining which addresses names meet the search's criteria, and
displaying the virtual subdomain addresses and/or their associated contacts information that meet the search criteria,
whereby the user can conduct a text search of the stored virtual subdomain addresses names

15) The method to manage contacts information as set forth in claim 11, further including the below steps added after step “storing said virtual subdomains in said data repository”:
providing a search facility, and
providing a data communications path to and from the Internet, and
querying said stored virtual subdomain addresses' associated contacts information using the said search facility and accessing the Internet, and
displaying the virtual subdomain addresses and/or associated contacts information that meet the search criteria,
whereby the user can conduct a search of the stored virtual subdomain addresses' content.

16) The method to manage contacts information comprising of the following steps:
providing a plurality of virtual subdomain addresses with:
i) differing domain names, and
ii) each of said virtual subdomain addresses has a person's name or representation of his name as part the subdomain name, and
iii) each of said virtual subdomain addresses when addressed using the hypertext transfer protocol of an Internet-connected web browser displays said person's associated contacts information on said browser, and
providing a database which one of its fields can hold virtual subdomain address and other fields can hold associated contacts information, and
storing said virtual subdomain addresses into said virtual subdomain address field, and
extracting, through the Internet, selective contacts information associated with said stored virtual subdomains addresses, and
storing said extracted contacts information into respective fields of said database,
whereby the user can store selective contacts information and eventually conduct a faster database search through its own, usually local database, rather than having to access the Internet for each virtual subdomain content search.

17) The method to manage contacts information as set forth in claim 15, further including the below steps added after step “storing said extracted contacts information into respective fields of said database,”:
providing a search facility to query the said database. and
querying said database, and
presenting the virtual subdomain addresses and/or their associated contacts information that meet the search criteria,
whereby the user can conduct a faster database search through its own, usually local database, rather than having to access the Internet for each virtual subdomain content search.

18) The method to manage contacts information as set forth in claim 16,
Said search facility can query said data repository and/or database when the system is without Internet access,
whereby the user can use the system without its Internet access.
